(19) United States
(12) Patent Application Publication
(10) Pub. No.: US 2023/0261881 A1
(43) Pub. Date: Aug. 17, 2023

(54) SECURE NETWORK ARCHITECTURE

(71) Applicant: Nokia Solutions and Networks Oy, Espoo (FI)

(72) Inventors: Shuning LIU, Shanghai (CN); Yifeng YAO, Shanghai (CN)

(21) Appl. No.: 18/003,524

(22) PCT Filed: Aug. 7, 2020
(86) PCT No.: PCT/CN2020/107737

§ 371 Date: Dec. 28, 2022

(51) Int. Cl. H04L 9/32; H04L 9/08

(52) U.S. Cl. CPC H04L 9/3247; H04L 9/3271; H04L 9/0891

(57) ABSTRACT

Embodiments of the present disclosure relate to devices, methods, apparatuses and computer readable storage media of secure network architecture. The method comprises transmitting, at a master device and to an access network device, a first level start-up request with a first identification signature corresponding to a first identification key for identifying the master device, the first identification key being generated based on a master key specific to the master device; receiving, from the access network device, a first level start-up authorization response with a first authorization signature corresponding to a second identification key; and verifying the first authorization signature with the first identification key.

### FIELD

Embodiments of the present disclosure generally relate to the field of telecommunication and in particular, to methods, devices, apparatuses and computer readable storage media for secure network architecture.

### BACKGROUND

Cloud-based network monitoring, control, analytics, service automation have been increasingly widely deployed. In such a network, a Wi-Fi Gateway or access point (AP) typically gets configurations from a cloud system. On the other hand, the network security becomes more and more important, as operators often face more professional attacks. In general, a network device may comprise multiple components or elements. Some of the components or elements may be compromised or stolen, especially for the network devices that are deployed in a public area. Therefore, identification, tracking, and integrity verification of the components, both in terms of hardware and software, are the most critical aspect for the network security. Without these, it's hard to know which device is being managed or controlled and whether the device is working correctly per managers' requirement.

Since there are lots of network attacks occurring in the network, a device may need to verify the integrity of software and protect privacy or sensitive data stored in the device. For example, at initial start-up, a device may determine that the software and data have not been modified or compromised to ensure that device works correctly. For another example, the privacy, sensitive user data is typically encrypted before storage on the device. Currently, hardcode key is used in some products for both integrity verification of software and data protection. The problem is that the same hardcode key is shared between all products delivered. In a case that one of these products is compromised, the rest of the products are compromised. In addition, crypto-technology is utilized to protect network security. While in the field of security and/or crypto-technology, key (or password) management is the critical issue, it's important to refresh/update the security keys when needed.

### SUMMARY

In general, example embodiments of the present disclosure provide a solution for secure network architecture.

In a first aspect, there is provided a master device. The master device comprises at least one processor; and at least one memory including computer program codes; the at least one memory and the computer program codes are configured to, with the at least one processor, cause the master device to transmit, to a network device, a first level start-up request with a first identification signature corresponding to a first identification key for identifying the master device, the first identification key being generated based on a master key specific to the master device; receive, from the network device, a first level start-up authorization response with a first authorization signature corresponding to a second identification key; and verify the first authorization signature with the first identification key.

In a second aspect, there is provided a slave device. The slave device comprises at least one processor; and at least one memory including computer program codes; the at least one memory and the computer program codes are configured to, with the at least one processor, cause the slave device to transmit, to a first target device, a second level start-up request with a first slave identification signature corresponding to a first slave identification key for identifying the slave device, the first slave identification key being generated based on a master key specific to the slave device; receive, from the first target device, a second level start-up authorization response with a first slave authorization signature corresponding to a second slave identification key, the slave device and the first target device being comprised in a group of devices each assigned with a corresponding device level, and a device level of the slave device is one device level lower than that of the first target device; and verify the first slave authorization signature with the first slave identification key.

In a third aspect, there is provided a network device. The network device comprises at least one processor; and at least one memory including computer program codes; the at least one memory and the computer program codes are configured to, with the at least one processor, cause the network device at least to receive, from a master device, a first level start-up request with a first identification signature corresponding to a first identification key for identifying the master device, the first identification key being generated based on a master key specific to the master device; verify the first identification signature with a second identification key; and in accordance with a determination that the verification of the first identification signature is correct, transmit, to the master device, a first level start-up authorization response with a first authorization signature corresponding to the second identification key.

In a fourth aspect, there is provided a method of communications. The method comprises transmitting, at a master device and to a network device, a first level start-up request with a first identification signature corresponding to a first identification key for identifying the master device, the first identification key being generated based on a master key specific to the master device; receiving, from the network device, a first level start-up authorization response with a first authorization signature corresponding to a second identification key; and verifying the first authorization signature with the first identification key.

In a fifth aspect, there is provided a method of communications. The method comprises transmitting, at a slave device and to a first target device, a second level start-up request with a first slave identification signature corresponding to a first slave identification key for identifying the slave device, the first slave identification key being generated based on a master key specific to the slave device; receiving, from the first target device, a second level start-up authorization response with a first slave authorization signature corresponding to a second slave identification key, the slave device and the first target device being comprised in a group of devices each assigned with a corresponding device level, and a device level of the slave device is one device level lower than that of the first target device; and verifying the first slave authorization signature with the first slave identification key.

In a sixth aspect, there is provided a method of communications. The method comprises receiving, at a network device, a first level start-up request with a first identification signature from a master device, the first identification signature corresponding to a first identification key for identifying the master device, and the first identification key being generated based on a master key specific to the master device; verifying the first identification signature with a second identification key; and encapsulating the third level start-up request with the second slave identification signature into the second level start-up request.

In a seventh aspect, there is provided an apparatus. The apparatus comprises means for or transmitting, to a network device, a first level start-up request with a first identification signature corresponding to a first identification key for identifying the master device, the first identification key being generated based on a master key specific to the master device; means for receiving, from the network device, a first level start-up authorization response with a first authorization signature corresponding to a second identification key; and means for verifying the first authorization signature with the first identification key.

In an eighth aspect, there is provided an apparatus. The apparatus comprises means for transmitting, to a first target device, a second level start-up request with a first slave identification signature corresponding to a first slave identification key for identifying the slave device, the first slave identification key being generated based on a master key specific to the slave device; means for receiving, from the first target device, a second level start-up authorization response with a first slave authorization signature corresponding to a second slave identification key, the slave device and the first target device being comprised in a group of devices each assigned with a corresponding device level, and a device level of the slave device is one device level lower than that of the first target device; and means for verifying the first slave authorization signature with the first slave identification key.

In a ninth aspect, there is provided an apparatus. The apparatus comprises means for receiving a first level start-up request with a first identification signature from a master device, the first identification signature corresponding to a first identification key for identifying the master device, and the first identification key being generated based on a master key specific to the master device; means for verifying the first identification signature with a second identification key; and means for encapsulating the third level start-up request with the second slave identification signature into the second level start-up request.

In a tenth aspect, there is provided a non-transitory computer readable medium comprising program instructions for causing an apparatus to perform at least the method according to the above fourth aspect.

In a eleventh aspect, there is provided a non-transitory computer readable medium comprising program instructions for causing an apparatus to perform at least the method according to the above fifth aspect.

In a twelfth aspect, there is provided a non-transitory computer readable medium comprising program instructions for causing an apparatus to perform at least the method according to the above sixth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example network architecture in which embodiments of the present disclosure may be implemented;

FIG. 2A illustrates a schematic diagram illustrating a network system including multiple network devices according to some embodiments of the present disclosure;

FIG. 2B illustrates a schematic diagram illustrating a network device according to some embodiments of the present disclosure;

FIG. 3 illustrates a schematic diagram illustrating key derivation according to some embodiments of the present disclosure;

FIG. 4 illustrates a flowchart illustrating an example start-up process of a network device according to some embodiments of the present disclosure;

FIG. 5A illustrates a diagram illustrating an example format of the first level start-up request signed with nested application signatures according to some embodiments of the present disclosure;

FIG. 5B illustrates a diagram illustrating an example format of the start-up authorization response signed with nested application signatures according to some embodiments of the present disclosure;

FIG. 6 illustrates a flowchart illustrating an example periodically authentication process of a network device according to some embodiments of the present disclosure;

FIG. 7 illustrates a diagram illustrating an example format of the challenge message signed with nested application signatures according to some embodiments of the present disclosure;

FIG. 8 illustrates a flowchart illustrating an example key update process of a network device according to some embodiments of the present disclosure;

FIG. 9 illustrates a diagram illustrating an example format of the key update message signed with nested application signatures according to some embodiments of the present disclosure;

FIG. 10 illustrates a flowchart of a method according to some embodiments of the present disclosure;

FIG. 11 illustrates a flowchart of a method according to some other embodiments of the present disclosure;

FIG. 12 illustrates a flowchart of a method according to some other embodiments of the present disclosure;

FIG. 13 illustrates a simplified block diagram of an apparatus that is suitable for implementing embodiments of the present disclosure; and

FIG. 14 illustrates a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:

(a) hardware-only circuit implementations (such as implementations in only analog and/or digital circuitry) and

(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and

(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as optical distribution network, gigabit passive optical network, Ethernet passive optical network, Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to an optical line terminal, optical network terminal, a line terminal, a network terminal, a gateway, an access server, a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

Usually, public key cryptography is used to exchange bulk data encryption keys, for example, Diffie-Hellman key exchange, RSA key exchange and so on. Since such key exchange technologies need extensive computation resources, neither of them is widely used on massive inexpensive devices, such as Digital Subscriber Line (DSL) modems, Residential gateways, optical network terminals and so on. An alternative way is to use private key cryptography directly, which is non-computation extensive algorithm, thus can be easily implemented with lower cost. For public key cryptography-based system, the same default key pair is configured as a default key on delivery and users with weak security awareness often do not change it. For private key cryptography, usually the same pre-share default key is configured in multiple devices or systems. If one of these devices or systems is compromised, all the devices or systems of the same type are compromised. Thus, unique key (pair) for each system/device is essential for sake of network security.

During manufacture, deployment and customization procedures, there are two ways to transport password/key together with devices, as well as update in use: 1) same password for all device, which usually defined in some standards and the drawback is that it's unable to change the password dynamically; and 2) unique password per device, which is printed on the face/bottom of the device in plaintext, and thus such keys/passwords are configured into device manually on deployment and may result in password leakage. Neither static nor fixed password is secure.

Currently, only the user authentication is verified by the operator during login, but no device authentication in the reverse direction as well as integrity verification of the system is performed. In other words, there is no solution for guaranteeing the true integrity of the network devices, and thus it is impossible to track down the network devices included in a system and/or their combination. Additionally, the integrity of software on the network devices is also required to be verified.

Wi-Fi Gateway or AP may get configuration data or files from a cloud system. Before configuration data is downloaded, the Gateway/AP is first authenticated based on passwords. Typically, the initialization password is available in plaintext, or easy to learn through known attack-technologies. Further there is no mechanism to update key/password and make it under protection. If the configuration data includes sensitive data, such data may be encrypted with hard coded keys. With the conventional solution, all encrypted customization or initialization data are encrypted by a key which is hardcoded in source code. However, it is possible to get the hardcode code from code and compromise devices through reverse engineering.

In view of the above, enhancements in terms of integrity verifications of network devices and software stored thereon, device tracking and data encryption are required for the network system. According to example embodiments of the present disclosure, a dynamic network device security protection scheme is proposed with improved functions such as dynamic key refresh, dynamic integrity verification in both system level and device level, communication/data encryption, component authentication, etc. With such an efficient protection scheme, mutual authentication between the network operator and the network system is supported, the legality of the hardware, for example, boards arranged in the network system is ensured or acceptable, and software stored on the network device can be prevented from being compromised.

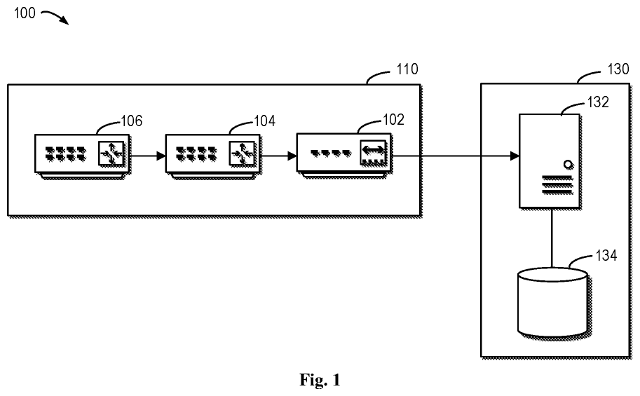

Principle and embodiments of the present disclosure will be described in detail below with reference to the accompanying drawings. Reference is first made to FIG. 1, which illustrates an example network architecture in which embodiments of the present disclosure may be implemented. The network architecture 100 includes a network system 110 and a network device 130. The network system 110 includes a plurality of network devices 102, 104 and 106, and each of the network devices 102 to 106 includes a corresponding secure memory storing keys specific to the respective network device, which will be discussed in details below. The network system 110 may further include an access client (not shown), including but not limited to RADIUS client, DIAMETER client, depending on the network protocol between the network system 110 and the network device 130. In the context of the present disclosure, the network devices 102 to 106 may also be referred to as “components”.

One of the network devices 102 to 106 may serve as a master device while others serve as slave devices. In the case as shown in FIG. 1, the network device 102 serves as the master device, and the network devices 104 and 106 serve as the slave device. In some example embodiments, the master device 102 may be integrated with the access client. In some other embodiments, the access client may be provided as a standalone device. In the context of the present disclosure, the network devices 102 to 106 may also be referred to as “components”, the network device 102 may also be referred to as “master device 102” and the network devices 104 and 106 may also be referred to as “slave devices 104 and 106”.

A corresponding device level is assigned to each of the network devices 102 to 106, with the master device 102 of a highest device level among the network devices (for example, a first device level), the slave device 104 of a second device level that is one device level lower than that of the master device, and the slave device 106 of the lowest device level (for example, a third device level). In other words, among the network devices, there may be nested master-slave relation, that is, a slave device may in turn act as a kind of master device with respect to the slave device with lower device levels.

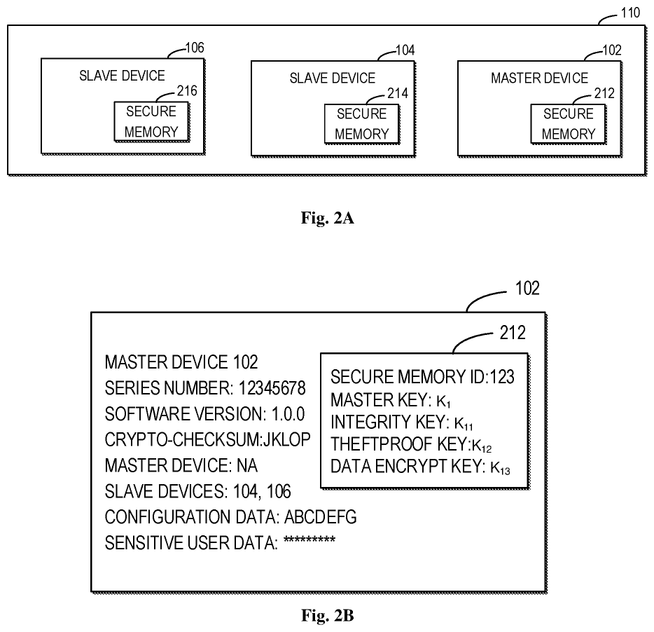

FIG. 2A illustrates a schematic diagram illustrating the network system 110 according to some embodiments of the present disclosure. As shown in FIG. 2A, for the network devices 102 to 106 of the network system 110, each includes a respective secure memory 212 to 216. In some example embodiments, the secure memory may be integrated with the network device, including but not limited to an active RFID tag, a trusted execution environment (TEE), physical unclonable function (PUF), a secured memory card and the like. From security viewpoint, secure memory may execute cryptographic algorithm securely and internally. FIG. 2B illustrates a schematic diagram illustrating the network device 102 according to some embodiments of the present disclosure. As shown in FIG. 2B, the secure memory in the network device may be is initialized with randomly generated keys for different applications including but not limited to an integrity key, an identification key and data encryption key and the like.

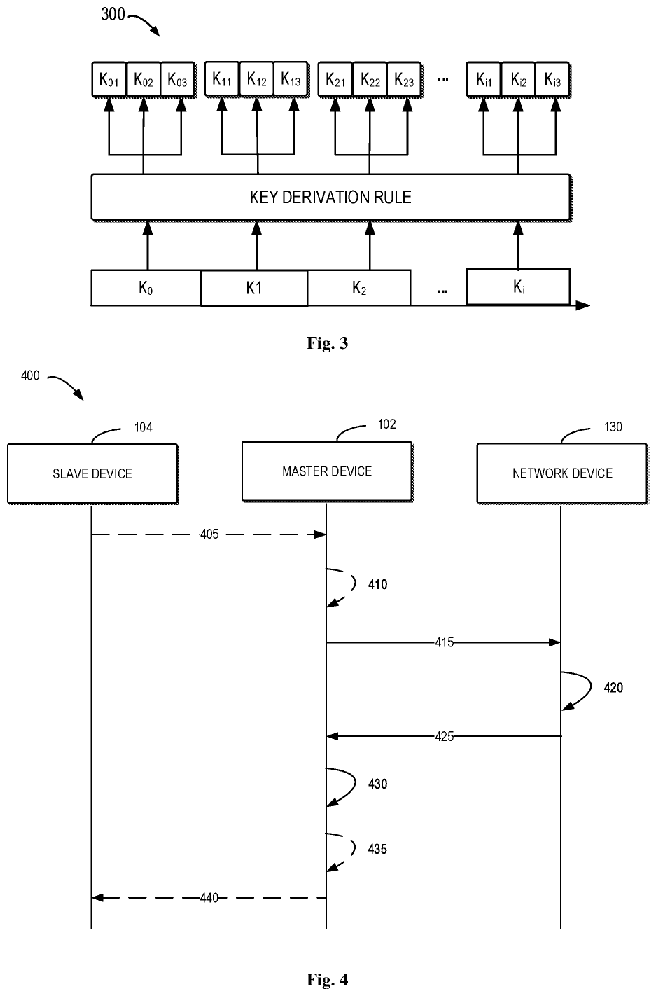

FIG. 3 illustrates a schematic diagram illustrating key derivation mechanism 300 according to some embodiments of the present disclosure. As shown in FIG. 3, at any of life cycles Cᵢ, such as C₀, C₁, C₂, and etc., a secure memory may store a corresponding unique master key Kᵢ (such as, K₀, K₁, K₂, etc.) and a group of application keys, such as Kᵢ₁, Kᵢ₂, Kᵢ₃, etc., which are derived from the master key Kᵢ with a key derivation rule, such as a key derivation algorithm. The master key Kᵢ and the group of application keys are specific to a corresponding network device. In other words, the master keys and the application keys vary from network devices, even for the same kind of network devices, the master keys and the application keys are different.

In some example embodiments, each of the network devices 102 to 106 may initialize an updating of the master key. In some other example embodiments, the updating of the master key may be initialized by the network device 130. The application keys may be updated after the updating of the master key. Based on secret keys in the secure memory, critical security features regarding identification, tracking and integrity verification of network device (both in terms of hardware and software/data) may be realized through several cryptographic protocols and messages. The generating of the application keys and the updating of the master key may be based on any suitable key derivation rule, such as MD5 algorithm, secure hash algorithm, or any other key derivation algorism, either currently existed or to be developed in the future.

As mentioned above, the access client, standalone or integrated with master device 102, is provided to connect the master device 102 with the network device 130 and forwards respective messages between the master device 102 and the network device 130. As such, the master device 102 may communicate with the network device 130 on behalf of all slave devices 104 and 106. For example, at start-up of the master device 102, the master device 102 may generate an access request, such as a start-up request, and transmit to the network device 130. Upon receipt of the access response from the network device 130, the access client may generate a star-up authorization response corresponding to the access response and transmit to the master device 102. In some example embodiments, the master device 102 may receive respective messages indicative of integrity query, key updating, data encryption, etc., with nested sub-messages from network device 130. In this case, the master device 102 may verify the received messages, distribute the nested content of the sub-messages to corresponding slave devices 104 and 106, and receive respective responses from slave devices. The master device 102 may then construct a nested response message accordingly, and transmit to the access client 120. This will be discussed in details below. In the following description, unless explicitly stated, the access client is described to be integrated with the master device 102. It should be understood that, the solutions provided in the example embodiments are also applicable to the configuration that the access client is separated from the master device.

The network device 130 may include an access server 132, such as Authentication, Authorization and Accounting (AAA) server based on RADIUS or DIAMETER protocol, and a central database 134. The central database 134 may be provided locally or remotely. The access server 132 may query the central database 134 for retrieve keys for device authentication, integrity verification and so on, which will be discussed in details below. The central database 132 may create a record for each of network devices 102 to 106, including network device ID, series number, a right software version of software image, and secure memory ID for identifying associated secure memory, as shown in table 1 below.

TABLE 1
The network device record

| Network | Series | Software | Associated secure |
|---|---|---|---|
| device ID | number | version | memory ID |
| 102 | 12345678 | 1.0.0 | 123 |

In addition, the network devices 130 may also store the master keys and the application keys specific to respective network devices 102-106. For example, the network device 130 may store the master keys and the application keys in the form of a RFID tag table. Table 2 below shows an example of key record table stored in the network device 130.

TABLE 2
Key record table

| Secure | | | Data | |
|---|---|---|---|---|
| memory | Integrity | Theftproof | encryption | Master |
| unit ID | key | key | key | key |
| 123 | K₁₁ | K₁₂ | K₁₃ | K₁ |

The central database 134 may store a constitution integrity table for recording the association relation between the network devices 102 to 106, such as the master-slave relation or the device levels. By way of example, in a case where a network system 110 is installed in network architecture 100 for the first time, the constitution integrity table is created and stored in the network device 130 for reflecting the constitution of the network system 110, especially the master-slave relation between components of the network system 110. Table. 3 below shows an example of the constitution integrity table stored in the network device 130.

TABLE 3
The constitution integrity table

| Network | Master | Slave | | |
|---|---|---|---|---|
| device ID | component | components | Master | slave |
| 102 | NA | 102, 104 | Y | N |
| 104 | 102 | NA | N | Y |
| 106 | 102 | 104 | N | Y |

The network system 110 can be extended by including one or more network devices, but there is only one master device for communicating with the network device 130. It is to be understood that the number of network devices, terminal devices, clients, servers, and/or database is given for the purpose of illustration without suggesting any limitations to the present disclosure. The network architecture 100 may include any suitable number of network devices, terminal devices, clients, servers, and/or database as well as any suitable devices not shown adapted for implementing implementations of the present disclosure.

In the network architecture 100 as shown in FIG. 1, the network system 110 can communicate data and control information to the network device 130, and the network device 130 can also communication data and control information to the network system 110. A link from the network device 130 to the network system 110 is referred to as a downlink (DL), while a link from the network system 110 to the network device 130 is referred to as an uplink (UL). In DL, the network device 130 is a transmitting (TX) device (or a transmitter) and the network system 110 is a receiving (RX) device (or a receiver). In UL, the network system 110 is a TX device (or a transmitter) and the network device 130 is a RX device (or a receiver).

Communications in the network architecture 100 may be implemented according to any proper communication protocol(s), comprising, but not limited to, broadband passive optical integrated access standard, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

In communication, a TX device may transmit a transport block including a plurality of code blocks or CBGs to a RX device. For example, in UL, the network device 130 may receive transport blocks from the network system 110. In DL, the network system 110 may receive a transport block from the network device 130. The reception state of each code block and/or CBG may be determined by the RX device and an indication of the reception state may be transmitted to the TX device to indicate the TX device whether retransmit the corresponding code block and/or CBG.

Reference is now made to FIG. 4, which illustrates a flowchart illustrating an example start-up process of a network device according to some embodiments of the present disclosure. For the purpose of discussion, the process 400 will be described with reference to FIG. 1. The process 400 may involve the master device 102 integrated with an access client, the slave device 104 and the network device 130 as illustrated in FIG. 1.

In the process 400, the master device 102 transmits 415 a first level start-up request with a first identification signature to the network device 130. In some example embodiments, the first level start-up request may include the series number and the request time information of the master device 102. The first level start-up request with a first identification signature may be transmitted in an access request message. The first identification signature corresponds to a first identification key for identifying the master device 102. As mentioned above, the first identification key Kᵢ₁ is generated based on the master key Kᵢ specific to the master device 102. For each of the network devices 102 to 106 in the network system 110, a corresponding first identification signature may be used as a theftproof signature for tracking the location of a respective network device and the constitution integrity of the network system 110.

Upon receipt of the first level start-up request, the network device 130 verifies 420 the first identification signature with a second identification signature. In some example embodiments, the network device 130 may be provided with the same key derivation rule as that of the network system 110. As such, the network device 130 may store respective master keys and groups of the application keys specific to each of the network devices 102-106. As an exemplary implementation, these keys may be stored in the central database 134, in the form of the key record table as shown in the above table 2, and the access server 132 may query the central database 134 to obtain the second identification key K_{i1′}.

If the verification is correct, the network device 130 generates a first level start-up authorization response with the second identification signature, and transmits 425 to the master device 102. In some example embodiments, the first level start-up authorization response with the second identification signature may be transmitted in an access authorization message.

Upon receipt of the first level start-up authorization with the second identification signature, the master device 102 verifies 430 the second identification signature with the first identification key. By way of example, the master device 102 may read the first identification key from the secure memory 212 for verifying the second identification signature. If the verification is correct, the master device 102 may be allowed to start up 440. If the verification is incorrect, the master device 102 may drop the first level start-up authorization response, and retransmit the first level start-up request to the network device 130.

In some example embodiments, the master device 102 may transmit a start-up request on behalf of the slave devices 104 and 106, as indicated above. In this case, the reception and transmission of messages and sub-messages between the network devices 102 to 106 are in the order of device levels. The master device 102 may receive 405 a second level start-up request with a first slave identification signature from a first slave device. The device level of the first slave device is one device level lower than the master device 102, for example, the slave device 104 as shown in FIG. 1. The second level start-up request may include a series number of the slave device 104 and request time information. The first slave identification signature corresponds to a slave identification key for identifying the slave device 104.

Before transmitting the second level start-up request to the network device 130, the master device 102 encapsulates 410 the second level start-up request with the first slave identification signature into the first level start-up request, and signs the first level start-up request with the first identification signature. In addition to the second level start-up request with the first slave identification signature, the master device 102 may further encapsulate the series number and the request time information of the master device 102 into the first level start-up request. As such, the second level start-up request with the first slave identification signature is an internal layer of the first level start-up request. In some example embodiments, the first level start-up request may be constructed with one or more internal layers, and each internal layer corresponds to a respective slave device with a specific device level. In other words, the first level start-up request may be nested with one or more slave identification signatures in the order of the device levels of the network devices of the network system, for example, in descending order of the device levels.

In this case, after receiving the first start-up authorization response from the network device 130 and verifying the authorization signature is correct, the master device 102 extracts 435 the internal layer of the first level start-up authorization response. In the example embodiments, internal layer of the first level start-up authorization response may be a second level start-up authorization response with a slave authorization signature. In some example embodiments, depending on the master-slave association and the constitution of the network system 110, the first level start-up authorization response may be constructed with one or more internal layers, and each internal layer corresponds to a respective slave device with a specific device level. In other words, the first level start-up authorization response may be nested with one or more slave authorization signatures in the order of the device levels, for example, in descending order of the device levels. By this way, the network device 130 is capable of tracking and identifying the each of the network devices 102 to 106 provided in the network system 110, and the constitution integrity of the network system 110 may be monitored.

The master device 102 may then transmit the internal layer of the first level start-up authorization response, that is, the second level start-up authorization response with a slave authorization signature to the slave device 104. In a case where a slave device with a lower device level requests for start-up, for example, the slave device 106 or a slave device with an even lower device level, the slave device 104 may perform similar operations as described above with respect to 430 to 440.

In some example embodiments, the slave device 104 receives the internal layer of the first level start-up authorization response, that is, the second level start-up authorization response with a slave authorization signature corresponding to the first slave identification key. The slave device 104 verifies the slave identification signature with the first slave identification key. If the verification of the slave identification signature is correct, the start-up of the slave device 104 may be completed. Alternatively, in a case where the slave device 104 is other than the network device with the lowest device order in network system 110, the slave device 104 may extract and transmit an internal layer of the second level start-up authorization response to the network device 106, that is, the network device of one device level lower than that of the slave device 104.

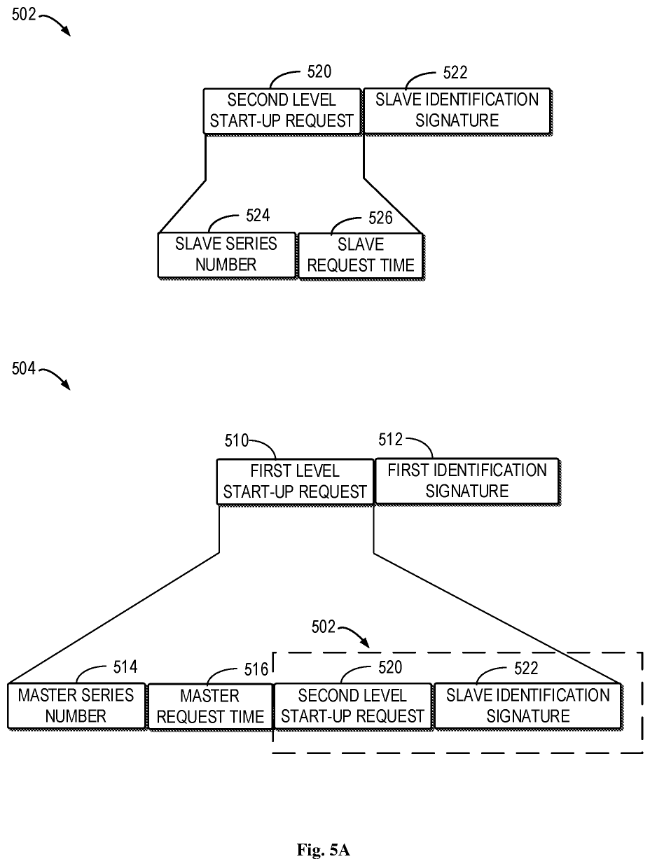

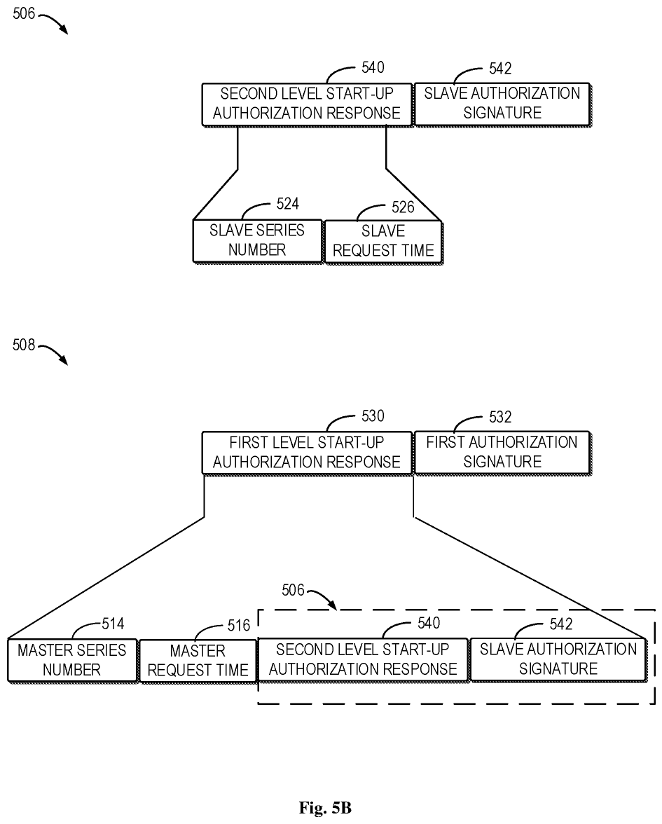

To better understand the multi-level nested message format according to the example embodiments of the disclosure, reference is now made to FIGS. 5A-5B. FIG. 5A illustrates an example format of the first level start-up request nested with at least one application signatures according to some embodiments of the present disclosure. FIG. 5B illustrates an example format of the start-up authorization response with at least one nested application signatures according to some embodiments of the present disclosure.

As shown in FIG. 5A, the second level start-up request 520 with the slave identification signature 522 may be constructed to be a second level start up request message 502 by the slave device 104. The second level start-up request 520 may also include the series number 524 and the request time 526 of the slave device 104. The second level start up request message 502 may be encapsulated into the first level start-up request 510 by the master device 102. The first level start-up request 510 may also include the series number 514 and the request time 516 of the master device 102. The master device 102 may then sign the first level start-up request 510 with the first identification signature 512 to form a first start-up request message 504.

The first level start-up authorization response message 508 may be constructed in an analogous manner to the first level start-up request message 504. As shown in FIG. 5B, the network device may construct the second level start-up authorization response 540 with a slave authorization signature 542. The second level start-up request 540 may also include the series number 524 and the request time 526 of the slave device 104. The second level start-up authorization response message 506 may be encapsulated into the first level start-up authorization response 530 by the network device 130. The first level start-up authorization response 530 may also include the series number 514 and the request time 516 of the slave device 102. The network device 130 may then sign the first level start-up authorization response 530 with the first authorization signature 532 to form a first start-up authorization response message 508.

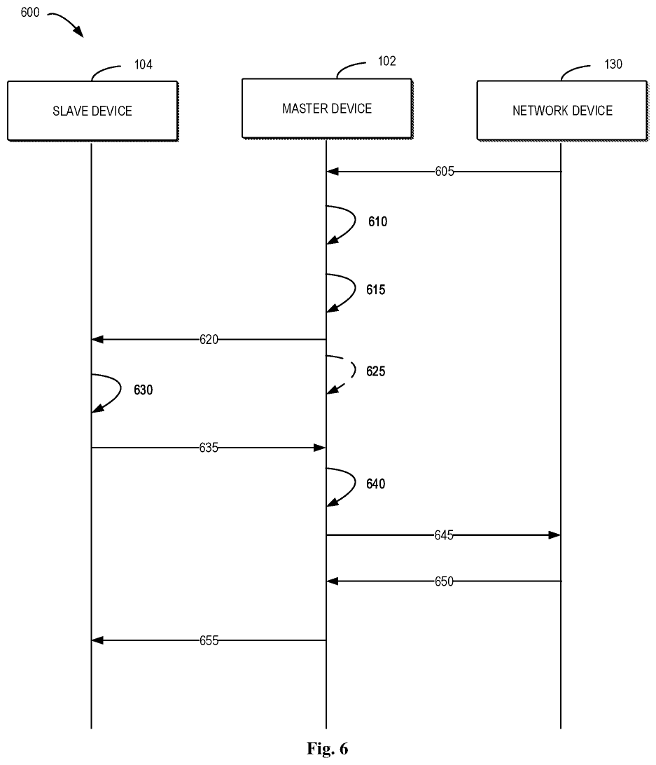

As previously mentioned, to ensure the constitution integrity of the network system 110, the network device may trace and identify presence of each of the network devices 102-106 periodically. FIG. 6 illustrates a flowchart illustrating an example periodically authentication process of a network device according to some embodiments of the present disclosure. For the purpose of discussion, the process 600 will be described with reference to FIG. 1. The process 600 may involve the master device 102 integrated with the access client, the slave device 104 and the network device 130 as illustrated in FIG. 1.

The network device 130 may determine whether all the network devices of the network system present correctly by transmitting a challenge message periodically. The network device 130 may then determine whether the constitution integrity of the network system 110 is maintained based on the determination result. The challenge message may be contracted in an analogous nested encapsulation manner to the authorization message. In some example embodiments, if no response to the challenge message is received from the network system 110, an alarm is raised in the network device 130 for indicating a possible movement of a network device, a change of the constitution of the network system and the like. In some other example embodiments, if one of the network devices 102-106 doesn't receive any challenge message, indicative of a possible movement of the corresponding network device, the network device may shut down automatically.

In the process 600, after the master device 102 and the slave device 104 are successfully start up, the network device 130 transmit 605, to the master device 102, a challenge message for verifying a constitution integrity of the group. The challenge message is signed with a challenge signature corresponding to the second identification key, and nested with at least one slave challenge signature corresponding to at least one slave identification key for identifying the at least one slave device in the order of device levels, for example, in descending order of device levels.

In some embodiments, the network device 130 is configured with the same key derivation rule as the network devices 102 to 106. By this way, the network device 130 may keep the same master key and the same group of application keys as those currently stored in respective secure memories of the network devices 102 to 106. As such, the challenge signature as well as the at least one slave challenge signature correspond to the first identification key and the at least one slave identification keys specific to the master device 102 and the slave device 104 and 106, respectively.

Upon receipt of the challenge message, the master device 102, the master device 102 verifies 610 the challenge signature with the first identification key specific to the master device 102. If the verification of the challenge signature is correct, the master device 102 extracts 615 an internal layer of the challenge message, for example, a second level challenge message with a slave challenge signature. The master device 102 transmits 620 the internal layer of the challenge message to the slave device 104 that is one device level lower than that of the master device 102.

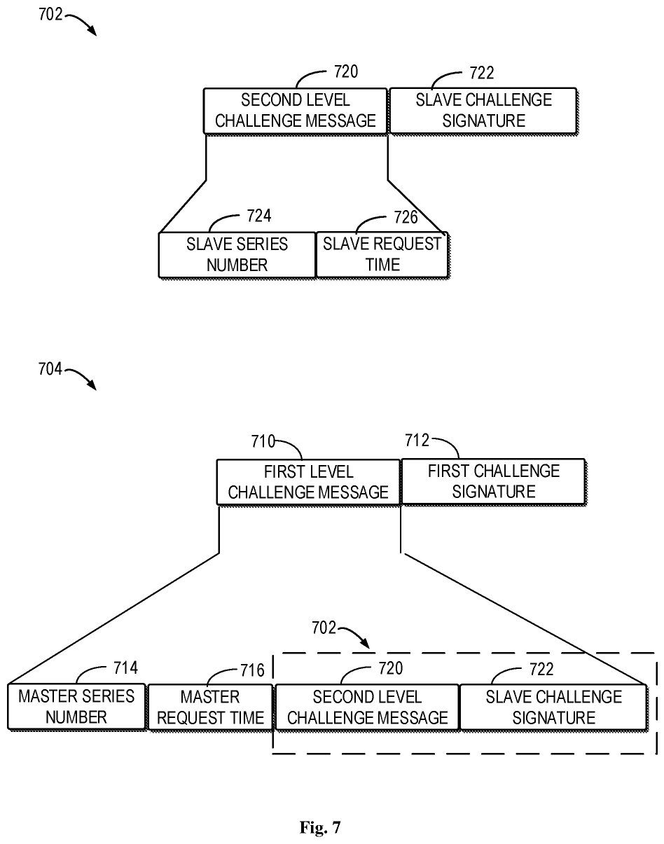

If the verification of the challenge signature is incorrect, the master device 102 drops 625 the challenge message. In this case, no response to the challenge message would be received at the network device 130. An example format of the challenge message is illustrated in FIG. 7 which will be discussed in detail later.

After receiving the second level challenge message with slave challenge signature, the slave device 104 verifies 630 the slave challenge signature with the first slave identification key specific to the slave device 104. If the verification of the slave challenge signature is correct, the slave device 104 may transmit 635 another second level start-up request with the first slave identification signature to the master device 102. The first slave identification signature corresponds to the first slave identification key specific to the slave device 104. The master device 102 may then encapsulate 640 the other second level start-up request with the first slave identification signature into another first level start-up request, and with the first identification signature and transmit 645 to the network device 130.

Upon receipt of another first level start-up request with the first identification signature from the master device 102, the network device 130 may perform analogous verifications as those in process 400, thus those similar steps will not be repeated herein. If all the verifications are correct, the network device 130 transmits 650 another first level start-up authorization response nested with at least one slave authorization signature to the master device 102, and the mater device 102 then transmit 655 another second level start-up authorization response to the slave device 104. In this case, the mater device 102 and slave device 104 may continue to operate. In some example embodiments, if one or more of the network devices of the network system 110 fails to receive the other first level start-up authorization response, or alternatively, if one or more of the network devices of the network system 110 receives no start-up authorization response before expiration of a periodical timer, the network system 110 may shut down automatically.

In some example embodiments, if the verification of the slave challenge signature is incorrect, the slave device 104 drops the second level challenge message. In this case, the network device would not receive any response to the challenge message from the master device, and alarm for a possible movement or absence of network device may rise in the network device 130. In some example embodiments, if one or more of network devices 102 to 106 does not receive any challenge message, the network system 110 may shut down automatically.

In order to protect software from being comprised, the example embodiments of the present disclosure propose an integrity check mechanism for software, data, configuration files used for a network system, especially for the network devices provided in the network system, for example, the network devices 102 to 106 of the network system 110.

The integrity key for checking integrity of data and a current version of the data stored on the network device may be generated based on the master key specific to the network device. Before start-up, the network device, for example, the network device 102 may check integrity of configuration file, data or software based on such an integrity key.

In some embodiments, an image of data, for example, software image may be obtained from the network device 130. The software image reflects a stored version of the data, for example, a right version without comprise of integrity, at the network device 130. The network device 102 may determine a first crypto-checksum based on the first integrity key for checking integrity of data and the current version of the data stored on the master device 102. In addition, the network device 102 may parse the software image for obtaining the software code and a second checksum from the software image.

The network device 102 may then compare the first crypto-checksum and the second crypto-checksum. If the first crypto-checksum is the same as the second crypto-checksum, the network device 130 may determine that the integrity check on the master device 102 is completed. Similarly, such an integrity check may be performed on each of the network devices 102-106. If the integrity check is failed or the software code is invalid, it means that the data stored on a corresponding network device may be compromised, and the start-up process of the corresponding network device may be suspended.

As such, a mutual authentication between the operator and the network system can be supported and the constitution integrity and software integrity of the network system 110 can be checked periodically, ensuring the legality and tracing of the network devices.

To better understand the multi-level nested format of the challenge message according to the example embodiments of the disclosure, reference is now made to FIG. 7. FIG. 7 illustrates a diagram illustrating an example format of the challenge message signed with nested application signatures according to some embodiments of the present disclosure.

As shown in FIG. 7, a second level challenge message 720 with the slave challenge signature 722 may be constructed to be a second level challenge indication 702 by the network device 130. The second level challenge message 720 may also include the series number 724 and the request time 726 of the slave device 104. The second level challenge indication 702 may be encapsulated into the first level challenge message 710 by the network device 130. The first level challenge message 710 may also include the series number 714 and the request time 716 of the master device 102. The network device 130 may then sign the first level challenge message 710 with the first challenge signature 712 to form a first level challenge indication 704.

To protect sensitive data to be delivered through configuration files or data files to the network devices 102 to 106 at installation, the data encryption key of the group of application keys may be used for encrypting such data. As shown in FIG. 3, like the integrity key and the identification key, the data encryption key is derived from the master key, and thus is unique to each of the network devices 102 to 106.

As an example, for the network device 102, the first data encryption key is generated based on the master key specific to the network device 102 and stored in the secure memory 212. In the start-up process, the network device 102 may receive configuration file comprising sensitive data from the network device 130. The configuration file is encrypted with the second data encryption key. The second data encryption key is generated based on the master key stored at the network device 130. The network device 102 may retrieve the first data encryption key from the secure memory 212 and then decrypt the encrypted configuration file with the first data encryption key.

As another example, before writing sensitive data into a network device, for example, the network device 104, such sensitive data may be encrypted with the data encryption key. Specifically, the network device 104 may retrieve the first data encryption key specific to the network device 104 from the secure memory 214 and encrypt the sensitive data with the first data encryption key. The encrypted sensitive data may then be written into the network device 104.

In the above embodiments, in a case where the data encryption key is updated or refreshed, the network device may be required to decrypt the encrypted sensitive data with the old data encryption key and then re-encrypt the sensitive data with the updated data encryption key. By this way, the data integrity can be guaranteed and the data transfer between the network devices of the network system 110 and the network device 130 is safe and reliable.

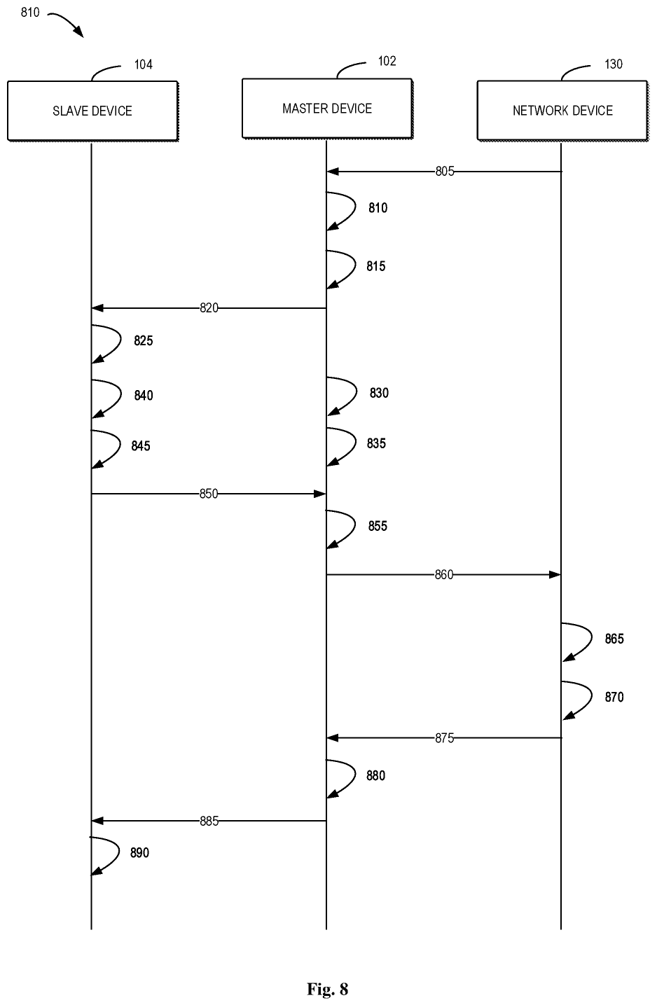

In order to enhance the security of the network system, the master key and the application keys specific to respective network devices may be updated. FIG. 8 illustrates a flowchart illustrating an example key updating process of a network device according to some embodiments of the present disclosure. For the purpose of discussion, the process 800 will be described with reference to FIG. 1. The process 800 may involve the master device 102 integrated with an access client, the slave device 104 and the network device 130 as illustrated in FIG. 1.

As mentioned, for a network device, the keys stored in the secure memory may be updated. The key updating process 800 may be initiated by either the network device 130 or the network devices 102-106. In a case where the key updating process 800 is initiated by the network device 130, the network device 130 transmits 805 a first level key updating message with the first key updating signature indicative of updating the master key to the master device 102.

Upon receipt of the first level key updating message, the master device 102 verifies 810 the first key updating signature with the first identification key. If the verification of the first key updating signature is correct, the master device 102 extracts the internal layer of the first level key updating message for obtaining 815815 the second level key updating message with a slave key updating signature, and transmits 820 to the slave device 104. The slave device 104 performs similar verification on the slave key updating signature to the master device 102. The slave key updating signature is verified 825 with the first slave identification key.

If all the verifications are correct, each of the network devices 102 to 106 of the network system 110 may update 830, 840 their corresponding master key from Kᵢ to Kᵢ₊₁ based on a preconfigured key updating rule and then generate 835, 845 the group of application keys {K_{i+1,1}, K_{i+1,2}, K_{i+1,3}}.

After updating the corresponding maser keys and the application keys, the slave device 104 transmits 850 another second level start-up request with the updated first slave identification signature corresponding to the updated first slave identification key to the master device 102.

The master device 102 encapsulates 855 the second level start-up request with the updated first slave identification signature into another first level start-up request and signed another first level start-up request with the updated first identification key. The master device 102 then transmits 860 the other first level start-up request with the updated first identification signature to the network device 130.

Like the authentication process as described in connection with FIG. 6, the network device 130 verifies 865 the nested updated identification signatures transmitted with the other first level start-up request in the order of the device levels. If all the verifications are correct, the network device 130 updates 870 the stored master keys and the corresponding applications keys based on the key derivation rule and transmits 875 another first level start-up authorization response with the updated second identification signature to the master device 102.

The master device 102, after receiving the other first level start-up authorization response, verifies 880 the updated second identification signature. If verification is correct, the master device 102 extracts the internal layer of the other first level start-up authorization response, i.e., another second level start-up authorization response with updated second slave identification signature, and transmits 885 to the slave device 104.

The slave device 104, after receiving the other second level start-up authorization response, verifies 890 the updated second slave identification signature. If the verification is correct and all the verifications of the updated second identification signatures are correct, the network devices 102 and 104 of the network system 110 keep operating. Otherwise, the network system 110 may be shut down automatically.

The above key updating process is also applicable to the constitution of network devices 102 to 106 and any other constitution of a group of network devices. The scope of the present disclosure is not limited to this aspect.

In some embodiments, the updating of master key and application keys may be initiated by the network devices 102 to 106, each time when the application keys are read. In other words, the key updating process is based on one-time-key mechanism. By way of example, for any key life cycle Cᵢ of the network device 102, at start-up, the first identification key Kᵢ₂ is read from the secure memory physically adhered to the network device 102. In a case where the first identification key Kᵢ₂ is available, the network device 102 transmits the first level start-up request with the first identification signature corresponding to the first identification key Kᵢ₂ to the network device 130. The network device 130 may then verify first level start-up request with the first identification signature and other association information. As discussed above, the first identification signature may be nested with at least one slave identification signature, meaning that more than one verification of the respective identification signatures may be performed. If all verifications are successful, it proves that the application key in secure memory is registered in network device 130. That is, the network device 102 with the associated tag is legal. The master key K₀ stored in the secure memory is updated to K₁ automatically via SHA-1 circuit when the secure memory is read or on receiving crypto key update command (and then K3, . . . , Ki, Ki+1, . . . ).

Base on above description, the master key and the application key stored in the secure memory are dynamically updated. The data between the secure memory and the reader as well as a back server of the network device is a hash value of Kᵢ together with other information, for example, key identification, rather than the application key itself, thus the communication of data is secure. Taking the secure one-way hash algorithm, such as MD5 as an example, it is impossible to revert any signature in form of a hash value to Kᵢ and {Kᵢ₁, Kᵢ₂, Kᵢ₃}. With proper key derivation rules, it is impossible to revert any of Kᵢ and {Kᵢ₁, Kᵢ₂, Kᵢ₃} from the signatures. Since Ki is unreadable from the tag, attackers are unable to generate the correct signatures in form of hash values. In addition, the damage of leakage of the application keys {Kᵢ₁, Kᵢ₂, Kᵢ₃} to the security of network system 110 is limited, since the master key Kᵢ is updated to Kᵢ₊₁ for the next time.

The authentication as described above is happened immediately after key updating, which allows the network device 130 to check whether the key updating is successful or not by verifying the signature of start-up request. If verification is successful with the updated key, the updating of key is successful. If no start-up request is received or verification is incorrect with the old key, then the updating of key is failed.

The updating of master key from Kᵢ to Kᵢ₊₁ is implemented automatically via SHA-1 circuit when the network device 102 to 106 receives the key updating indication. And at the same time, the back server also does the same operation to synchronize the key updating. The back server also needs to record the latest received request to recovery synchronization between the tag and server if key synchronization is lost.

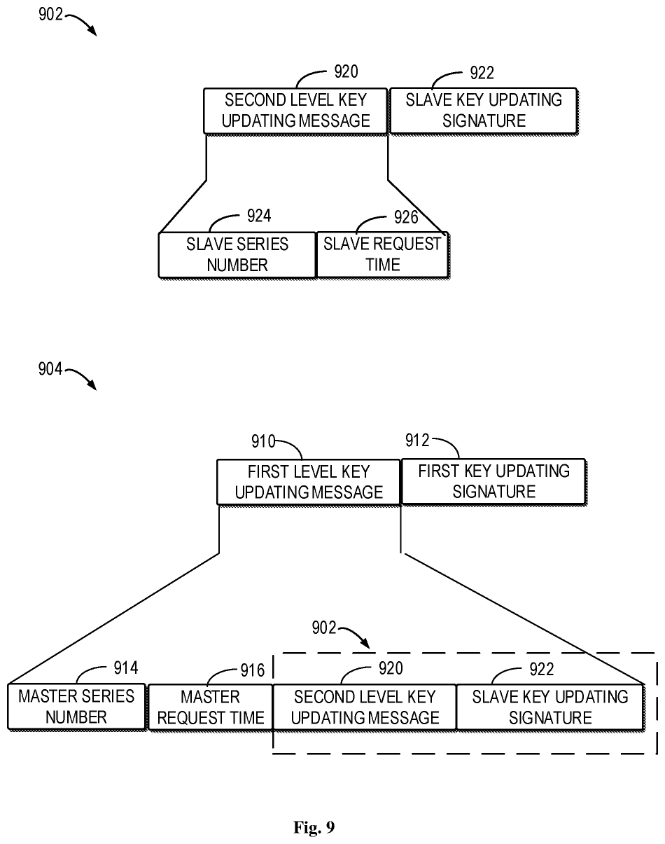

To better understand the multi-level nested format of the key updating message according to the example embodiments of the disclosure, reference is now made to FIG. 9. FIG. 9 illustrates a diagram illustrating an example format of the key update message signed with nested application signatures according to some embodiments of the present disclosure.

As shown in FIG. 9, a second level key updating message 920 with the slave key updating signature 922 may be constructed to be a second level key updating indication 902 by the network device 130. The second level key updating message 920 may also include the series number 924 and the request time 926 of the slave device 104. The second level key updating indication 902 may be encapsulated into the first level key updating message 910 by the network device 130. The first level key updating message 910 may also include the series number 914 and the request time 916 of the master device 102. The network device 130 may then sign the first level key updating message 710 with the first key updating signature 912 to form a first level key updating indication 904.

The example embodiments of the present disclosure propose a secure crypto key updating solution for providing the network system with additional security. In addition, the solution is applicable to all the products for password/key management and flexible for future security features, such as, device tracing, authentication and so on.

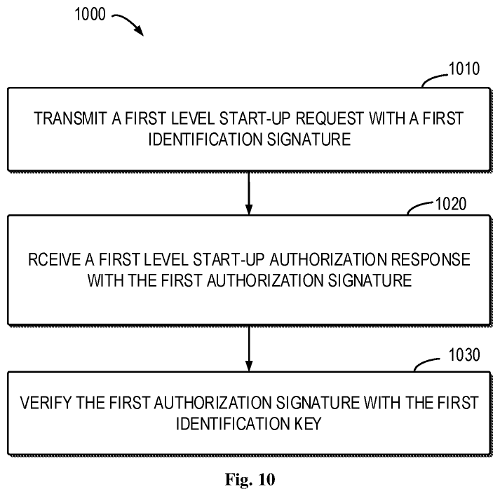

FIG. 10 illustrates a flowchart of a method according to some embodiments of the present disclosure. The method 1000 can be implemented at the master device 102 as shown in FIG. 1. For the purpose of discussion, the method 1000 will be described with reference to FIG. 1.

As shown in FIG. 10, at 1010, the master device 102 transmits, to the network device 130, a first level start-up request with a first identification signature. The first identification signature corresponds to the first identification key for identifying the master device 102. The first identification key is generated based on the master key specific to the master device 102.

At 1020, the master device 102 receives the first level start-up authorization response with the first authorization signature from the network device 130. The first authorization signature corresponds to the second identification key. In some example embodiments, the second identification key is generated based on the master key with the same key derivation rule as the network devices. The second identification key may be stored at the network device 130, for example, in the central database 134.

At 1030, the master device 102 verifies the first authorization signature with the first identification key. If the verification of the first authorization signature is correct, the start-up of the master device 102 is completed. In this case, the master device is allowed to start up. Otherwise, if the verification of the first authorization signature is incorrect, the master device 102 may drop the first level start-up authorization response, and the start-up of the master device 102 is suspended.

In some embodiments, the master device 102 may store the master key and a group of application keys generated based on the master key in a secure memory, for example, the secure memory 212 as shown in FIG. 2. The secure memory may include but not limited to, an active RFID tag, trusted execution environment (TEE), a physical unclonable function (PUF) based device, and a secure memory card, and the group of application keys comprising at least one of the first identification key, a first data encryption key and a first integrity key

In some embodiments, the master device 102 may include a network device integrated with an AAA client, and the network device 130 may include a AAA server and a central database.

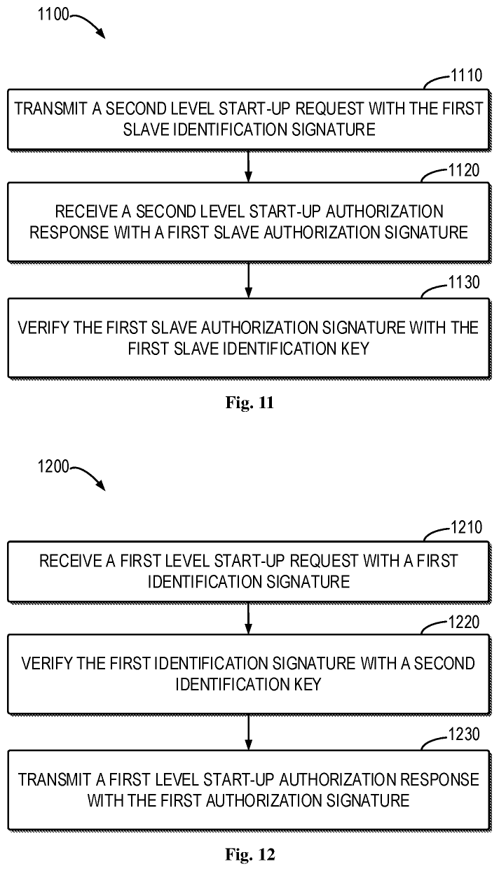

FIG. 11 illustrates a flowchart of a method according to some embodiments of the present disclosure. The method 1100 can be implemented at the slave device 104 as shown in FIG. 1. For the purpose of discussion, the method 1100 will be described with reference to FIG. 1.

As shown in FIG. 11, at 1110, the slave device 104 transmits the second level start-up request with the first slave identification signature to a first target device. In this case, the first target device may be the master device 102. The first slave identification signature corresponds to the first slave identification key for identifying the slave device 104. The first slave identification key is generated based on the master key specific to the slave device 104.

In some embodiments, the second level start-up authorization response with the first slave authorization signature may be an internal layer of the first level start-up authorization response extracted by the first target device with the first identification key. In this case, the first level start-up authorization response is generated and nested with a first authorization signature corresponding to a second identification key specific to the first target device and the first slave authorization signature corresponding to a second slave identification key in the order of device levels.

In some embodiments, the slave device 104 may receive configuration file including sensitive data. The configuration file may be delivered from the network device 130 and encrypted with the second slave data encryption key specific to the slave device 104. The slave device 104 may decrypt the encrypted configuration file with the first slave data encryption key, which is generated based on the master key specific to the slave device 104.

In some embodiments, the slave device 104 may use the first slave data encryption key for encrypting sensitive data, and write the encrypted sensitive data into the slave device 104.

At 1120, the slave device 104 receives the second level start-up authorization response with a first slave authorization signature from the first target device. The first slave authorization signature corresponds to the second slave identification key. In some example embodiments, the second identification key is generated based on the master key with the same key derivation rule as the network devices. The second identification key may be stored at the network device 130, for example, in the central database 134.

The slave device 104 and the first target device 102 are included in a group of devices, i.e., the network system 110, and each of the group of devices is assigned with a corresponding device level. In this case, a device level of the slave device 104 is one device level lower than that of the first target device 102.

At 1130, the slave device 104 verifies the first slave authorization signature with the first slave identification key. If the verification of the first slave authorization signature is correct, the start-up of the slave device 104 is completed. For example, the slave device 104 is allowed to start up. Otherwise, if the verification of the first slave authorization signature is incorrect, the slave device 104 drops the second level start-up authorization response and the start-up of the slave device 104 is suspended. In some example embodiments, the first level start-up authorization response is constructed to be signed with at least one slave authorization signature, as discussed above.

In some embodiments, after start-up, the slave device 104 may receive the second level challenge message for verifying the constitution integrity of the group of devices from the first target device. The second level challenge message is transmitted with the slave challenge signature corresponding to the second slave identification key. In this case, the slave device 104 may verify the slave challenge signature with the first slave identification key. If the verification of the slave challenge signature is correct, the slave device 104 transmits another second level start-up request with the first slave identification signature corresponding to the first slave identification key to the first target device. If the verification of the slave challenge signature is incorrect, the slave device 104 may drop the second level challenge message.

In some embodiments, after the successful verification of the slave challenge signature, the slave device 104 may extract the internal layer of the second level challenge message and transmit the internal layer of the second level message to the second target device, for example, the slave device 106.

In some embodiments, the slave device 104 may determine a first slave crypto-checksum based on a first slave integrity key for checking integrity of data and a current version of the data stored on the slave device 104. The first slave integrity key is generated based on the master key specific to the slave device 104. If the first slave crypto-checksum is the same as the second slave crypto-checksum obtained from an network device, the slave device 104 determines that the integrity check on the slave device 104 is completed. In this case, the second slave crypto-checksum is generated by the network device based on a stored version of the data and a second slave integrity key.

In some embodiments, the slave device 104 may receive the third level start-up request with the second slave identification signature from the second target device of the group of devices, for example, the slave device 106. The second slave identification signature corresponds to the second slave identification key for identifying slave device 106, and a device level of the second target device 106 is one device level lower than that of the slave device 104. In this case, the slave device 104 may encapsulate the third level start-up request with the second slave identification signature into the second level start-up request.

in the above embodiments, the slave device 104 may receive the second level start-up authorization response nested with at least a second slave authorization signature corresponding to the second target device 106. In this case, after the successful verification of first slave authorization signature, the slave device 104 may extract an internal layer of the second level start-up authorization response and transmit the internal layer of the second level start-up authorization response to the second target device.

In some embodiments, the slave device 104 may store the master key and a group of application keys generated based on the master key in the secure memory, for example, the secure memory 214 as shown in FIG. 2. The secure memory includes but not limited to, an active RFID tag, trusted execution environment (TEE), a physical unclonable function (PUF) based device, and a secure memory card, and the group of application keys comprising at least one of the first slave identification key, a first slave data encryption key and a first slave integrity key.

FIG. 12 illustrates a flowchart of a method according to some embodiments of the present disclosure. The method 1200 can be implemented at the network device 130 as shown in FIG. 1. For the purpose of discussion, the method 1200 will be described with reference to FIG. 1.

As shown in FIG. 12, at 1210, the network device 130 receives the first level start-up request with a first identification signature from the master device 102. The first identification signature corresponds to the first identification key for identifying the master device 102. The first identification key is generated based on the master key specific to the master device 102.

At 1220, the network device 130 verifies the first identification signature with the second identification key. As discussed above, the second identification key is generated based on the master key with the same key derivation rule as the network devices. The second identification key may be stored at the network device 130, for example, in the central database 134.

If the verification of the first identification signature is correct, at 1230, the network device 130 transmits the first level start-up authorization response with the first authorization signature to the master device 102. The first authorization signature corresponding to the second identification key. In some example embodiments, the first level start-up authorization response is constructed to be signed with at least one slave authorization signature, as discussed above.

In some embodiments, the network device 130 may encrypt configuration files that include sensitive data with the second data encryption key. The second data encryption key is generated based on the master key specific to network device, for example, the master device 102. The network device 130 may then transmit the encrypted configuration file to the master device 102.

In some embodiments, the network device 130 may transmit a challenge message for verifying constitution integrity of the network system 110 to the master device 102. The challenge message is transmitted with the challenge signature corresponding to the second identification key, and nested with at least one slave challenge signatures corresponding to at least one slave identification key for identifying the at least one slave device in the order of device levels. In this case, the network device 130 may receive another first level start-up request with the first identification signature and nested with the at least one slave identification signatures from the master device 102.

In the above embodiments, the network device 130 may verify the nested at least one slave identification signatures with at least one second slave identification key recorded in the constitution integrity table. The constitution integrity table indicates the cascading association between the network devices 102 to 106 in the network system 110.

In the above embodiments, the network device 130 may transmit the key update message indicative of updating master keys specific to the master device 102 and the at least one slave device 104 and 106 to the master device 102. The network device 130 may then receive another first level start-up request with a updated first identification signature corresponding to the updated first identification key specific to the master device 102. The other first level start-up request is nested with at least one slave identification signature corresponding to the updated first slave identification key specific to the at least one slave device 104 and 106.

In this case, The network device 130 may verify the updated first identification signature and the at least one slave identification signature in the order of device levels of the master device and the at least one slave device with the second identification key and at least one second slave identification key. If the verifications of the updated first identification key and the at least one slave identification signature are correct, the network device 130 may transmit another first level start-up authorization response with the first authorization signature to the master device 102. The other first level start-up authorization response is nested with at least one first slave authorization signature corresponding to the at least one second slave identification key. The network device 130 may then update the master keys specific to the master device 102 and the at least one slave device 104 and 106, and update at least the second identification keys based on the updated master keys.

In some embodiments, if the verification of the first identification signature is correct, the network device 130 may verify the at least one slave identification signature with at least one second slave identification key recorded in a constitution integrity table for indicating associations between the group of the devices. If the verification of the at least one slave identification signature is correct, the network device 130 may transmit the first level start-up authorization response with the first authorization signature to the master device 102. The first level start-up authorization response is nested with at least one slave authorization signature corresponding to the at least one slave device 104 and 106 in the order of device levels of the group of devices.

In some embodiments, the master device 102 may include a network device integrated with an AAA client, and the network device may include a AAA server and a central database.

According the example embodiments of the present disclosure, the secure network architecture can support identification, tracking and integrity check for network elements, and thus ensuring the security of the network systems. By using unique password or key per system/device on delivery or in deployment, the security of the network system can be enhanced. In addition, the secure network architecture is compliant with existing system security standards and can be implemented by reusing the existed network architectures and protocols, making it easy to deploy.

In some example embodiments, an apparatus capable of performing the method 1000 may comprise means for performing the respective steps of the method 1000. The means may be implemented in any suitable form. For example, the means may be implemented in a circuitry or software module.

In some example embodiments, the apparatus comprises: means for transmitting, to an network device, a first level start-up request with a first identification signature corresponding to a first identification key for identifying the master device, the first identification key being generated based on a master key specific to the master device; means for receiving, from the network device, a first level start-up authorization response with a first authorization signature corresponding to a second identification key; and means for verifying the first authorization signature with the first identification key.

In some example embodiments, the apparatus further comprises: means for in accordance with a determination that the verification of the first authorization signature is correct, completing the start-up of the master device; and means for in accordance with a determination that the verification of the first authorization signature is incorrect, dropping the first level start-up authorization response.

In some example embodiments, the apparatus further comprises: means for receiving, from the network device, configuration file comprising sensitive data, the configuration file being encrypted with a second data encryption key; and means for decrypting the encrypted configuration file with a first data encryption key, the first data encryption key being generated based on the master key specific to the master device.

In some example embodiments, the apparatus further comprises: means for in accordance with a determination of sensitive data to be written into the master device, encrypting the sensitive data with a first data encryption key, the first data encryption key being generated based on the master key specific to the master device; and means for writing the encrypted sensitive data into the master device.

In some example embodiments, the master device is comprised in a group of devices with at least one slave device, and each of the group of devices is assigned with a corresponding device level, and the apparatus further comprises: means for receiving, from the network device, a challenge message for verifying a constitution integrity of the group, the challenge message being with a challenge signature corresponding to the second identification key, and nested with at least one slave challenge signature corresponding to at least one slave identification key for identifying the at least one slave device in the order of device levels; means for verifying the challenge signature with the first identification key specific to the master device; and means for in accordance with a determination that the verification of the challenge signature is correct, extracting an internal layer of the challenge message; means for transmitting the internal layer of the challenge message to a first slave device, a device level of the first slave device is one device level lower than that of the master device; and means for in accordance with a determination that the verification of the challenge signature is incorrect, dropping the challenge message.

In some example embodiments, the apparatus further comprises: means for determining a first crypto-checksum based on a first integrity key for checking integrity of data and a current version of the data stored on the master device, the first integrity key being generated based on the master key specific to the master device; and in accordance with a determination that the first crypto-checksum is the same as a second crypto-checksum obtained from a network device, determining that an integrity check on the master device is completed, the second crypto-checksum being generated by the network device based on a stored version of the data and a second integrity key.

In some example embodiments, the apparatus further comprises: means for updating the master key based on a preconfigured key updating rule; and means for updating at least the first identification key based on the updated master key.

In some example embodiments, means for updating the master key comprises: means for receiving, from the network device, a key update message indicative of updating the master key; and means for in response to the key update message, updating the master key based on the preconfigured key updating rule.

In some example embodiments, the apparatus further comprises: means for transmitting another first level start-up request with a updated first identification signature corresponding to the updated first identification key; means for receiving, from the network device, another first level start-up authorization response with a second authorization signature corresponding to a third identification key; and means for verifying the second authorization with the updated first identification key.

In some example embodiments, the master device is comprised in a group of devices with at least one slave device, and each of the group of devices is assigned with a corresponding device level, and the apparatus further comprises: means for receiving, from a first slave device of the group of devices, a second level start-up request with a first slave identification signature corresponding to a slave identification key for identifying the first slave device, a device level of the first slave device being one device level lower than that of the master device; and means for encapsulating the second level start-up request with the first slave identification signature into the first level start-up request.

In some example embodiments, the first level start-up authorization response is nested with at least a second level authorization signature corresponding to the first slave device, and the apparatus further comprises: means for in accordance with a determination that the verification of the first authorization signature is correct, extracting an internal layer of the first level start-up authorization response; means for transmitting the internal layer of the first level start-up authorization response to the first slave device; and means for in accordance with a determination that the verification of the first authorization signature is incorrect, dropping the first level start-up authorization response.

In some example embodiments, the apparatus further comprises: means for storing the master key and a group of application keys generated based on the master key in a secure memory, the secure memory comprising at least one of an active RFID tag, trusted execution environment (TEE), a physical unclonable function (PUF) based device, and a secure memory card, and the group of application keys comprising at least one of the first identification key, a first data encryption key and a first integrity key.

In some example embodiments, the master device comprises a network device integrated with an AAA client, and the network device comprises a AAA server and a central database.

In some example embodiments, an apparatus capable of performing the method 1100 may comprise means for performing the respective steps of the method 1100. The means may be implemented in any suitable form. For example, the means may be implemented in a circuitry or software module.

In some example embodiments, the apparatus comprises: means for transmitting, at a slave device and to a first target device, a second level start-up request with a first slave identification signature corresponding to a first slave identification key for identifying the slave device, the first slave identification key being generated based on a master key specific to the slave device; means for receiving, from the first target device, a second level start-up authorization response with a first slave authorization signature corresponding to a second slave identification key, the slave device and the first target device being comprised in a group of devices each assigned with a corresponding device level, and a device level of the slave device is one device level lower than that of the first target device; and means for receiving, from the first target device, a second level start-up authorization response with a first slave authorization signature corresponding to a second slave identification key, the slave device and the first target device being comprised in a group of devices each assigned with a corresponding device level, and a device level of the slave device is one device level lower than that of the first target device.

In some example embodiments, the apparatus further comprises: means for in accordance with a determination that the verification of the first slave authorization signature is correct, completing the start-up of the slave device; and means for in accordance with a determination that the verification of the first slave authorization signature is incorrect, dropping the second level start-up authorization response.

In some example embodiments, the second level start-up authorization response with the first slave authorization signature is an internal layer of a first level start-up authorization response extracted by the first target device with the first identification key specific to the first target device, and the first level start-up authorization response is generated and nested, by the network device, with a first authorization signature corresponding to a second identification key specific to the first target device and the first slave authorization signature corresponding to a second slave identification key in the order of device levels.

In some example embodiments, the apparatus further comprises: means for receiving, from the first target device, configuration file including sensitive data, the configuration file being delivered from a network device and encrypted with a second slave data encryption key; and means for decrypting the encrypted configuration file with a first slave data encryption key, the first slave data encryption key being generated based on the master key specific to the slave device.

In some example embodiments, the apparatus further comprises: means for in accordance with a determination of sensitive data to be written into the slave device, encrypting the sensitive data with a first slave data encryption key, the first slave data encryption key being generated based on the master key specific to the slave device; and means for writing the encrypted sensitive data into the slave device.

In some example embodiments, the slave device is of a lowest device level in the group of devices, and the apparatus further comprises: means for in accordance with a determination that the verification of the first slave authorization signature is correct, completing the start-up of the slave device; means for receiving, from the first target device, a second level challenge message for verifying a constitution integrity of the group of devices, the second level challenge message being with a slave challenge signature corresponding to the second slave identification key; means for verifying the slave challenge signature with the first slave identification key specific to the slave device; means for in accordance with a determination that the verification of the slave challenge signature is correct, transmitting, to the first target device, another second level start-up request with the first slave identification signature corresponding to the first slave identification key; and means for in accordance with a determination that the verification of the slave challenge signature is incorrect, dropping the second level challenge message.

In some example embodiments, a device level of the slave device is a first device level other than a lowest device level, and the apparatus further comprises: means for in accordance with a determination that the verification of the first slave authorization signature is correct, completing the start-up of the slave device; means for receiving, from the first target device, a second level challenge message for verifying a constitution integrity of the group of devices, the second level challenge message with a slave challenge signature corresponding to the second slave identification key and nested with at least a third slave identification signature corresponding to a third identification key specific to a second target device of the group of devices, a device level of the second target device being one device level lower than that of the slave device; means for verifying the slave challenge signature with the first slave identification key specific to the slave device; means for in accordance with a determination that the verification of the slave challenge signature is correct, extracting an internal layer of the second level challenge message; means for transmitting the internal layer of the second level message to the second target device; and means for in accordance with a determination that the verification of the slave challenge signature is incorrect, dropping the second level challenge message.

In some example embodiments, the apparatus further comprises: determining a first slave crypto-checksum based on a first slave integrity key for checking integrity of data and a current version of the data stored on the slave device, the first slave integrity key being generated based on the master key specific to the slave device; and means for in accordance with a determination that the first slave crypto-checksum is the same as a second slave crypto-checksum obtained from a network device, determining that an integrity check on the slave device is completed, the second slave crypto-checksum being generated by the network device based on a stored version of the data and a second slave integrity key.

In some example embodiments, the apparatus further comprises: means for in accordance with a determination that the verification of the first slave authorization signature is correct, completing the start-up of the slave device; means for updating the master key based on a preconfigured key updating rule; and means for updating at least the first slave identification key based on the updated master key.

In some example embodiments, means for updating the master key comprises: means for receiving, from the first target device, a second level key update message indicative of updating the master key; and means for in response to the second level key update message, updating the master key based on the preconfigured key updating rule.

In some example embodiments, the apparatus further comprises: means for transmitting another second level start-up request with a updated first slave identification signature corresponding to the updated first slave identification key; means for receiving, from the first target device, another second level start-up authorization response with a third slave authorization signature corresponding to a third slave identification key other than the second slave identification key; and means for verifying the third slave identification signature with the updated first slave identification key.

In some example embodiments, the slave device is of a first device level other than a lowest device level, and the apparatus further comprises: means for receiving, from a second target device of the group of devices, a third level start-up request with a second slave identification signature corresponding to a second slave identification key for identifying the second target device, a device level of the second target device being one device level lower than that of the slave device; and means for encapsulating the third level start-up request with the second slave identification signature into the second level start-up request.

In some example embodiments, the second level start-up authorization response is nested with at least a second slave authorization signature corresponding to the second target device, and the apparatus further comprises: means for in accordance with a determination that the verification of first slave authorization signature is correct, extracting an internal layer of the second level start-up authorization response; means for transmitting the internal layer of the second level start-up authorization response to the second target device; and means for in accordance with a determination that the verification of the second level is incorrect, dropping the first slave start-up authorization response.

In some example embodiments, the apparatus further comprises: means for storing the master key and a group of application keys generated based on the master key in a secure memory, the secure memory comprising at least one of an active RFID tag, trusted execution environment (TEE), a physical unclonable function (PUF) based device, and a secure memory card, and the group of application keys comprising at least one of the first slave identification key, a first slave data encryption key and a first slave integrity key.

In some example embodiments, the first target device comprises a master device of the group of devices with a highest device level and integrated with an AAA client, the slave device comprises one of a gateway and an access point, and the network device comprises an AAA server and a central database.

In some example embodiments, an apparatus capable of performing the method 1200 may comprise means for performing the respective steps of the method 1200. The means may be implemented in any suitable form. For example, the means may be implemented in a circuitry or software module.

In some example embodiments, the apparatus comprises: means for receiving, at a network device, a first level start-up request with a first identification signature from a master device, the first identification signature corresponding to a first identification key for identifying the master device, and the first identification key being generated based on a master key specific to the master device; means for verifying the first identification signature with a second identification key; and means for in accordance with a determination that the verification of the first identification signature is correct, transmitting, to the master device, a first level start-up authorization response with a first authorization signature corresponding to the second identification key.

In some example embodiments, the apparatus further comprises: means for encrypting configuration file including sensitive data with a second data encryption key, the second data encryption key being generated based on the master key specific to the master device; and means for transmitting the encrypted configuration file to the master device.

In some example embodiments, the apparatus further comprises: means for transmitting, to the master device, a challenge message for verifying a constitution integrity of the group, the challenge message being with a challenge signature corresponding to the second identification key, and nested with at least one slave challenge signatures corresponding to at least one slave identification key for identifying the at least one slave device in the order of device levels; means for receiving, from the master device, another first level start-up request being with the first identification signature and nested with the at least one slave identification signatures; and means for verifying the nested at least one slave identification signatures with at least one second slave identification key recorded in a constitution integrity table for indicating associations between the group of the devices.

In some example embodiments, the master device is included in a group of devices with at least one slave device, each of the group of devices is assigned with a corresponding device level, and the apparatus further comprises: means for transmitting, to the master device, a key update message indicative of updating master keys specific to the master device and the at least one slave device; means for receiving another first level start-up request with a updated first identification signature corresponding to the updated first identification key specific to the master device, the other first level start-up request being nested with at least one slave identification signature corresponding to the updated first slave identification key specific to the at least one slave device; means for verifying the updated first identification signature and the at least one slave identification signature in the order of device levels of the master device and the at least one slave device with the second identification key and at least one second slave identification key; means for in accordance with the verifications of the updated first identification key and the at least one slave identification signature are correct, transmitting another first level start-up authorization response with the first authorization signature to the master device, the other first level start-up authorization response being nested with at least one first slave authorization signature corresponding to the at least one second slave identification key; means for updating the master keys specific to the master device and the at least one slave device; and means for updating at least the second identification keys based on the updated master keys.

In some example embodiments, the master device is comprised in a group of devices with at least one slave device, and each of the group of devices is assigned with a corresponding device level, the first level start-up request being nested with at least one slave identification signatures corresponding to the at least one slave device in the order of device levels of the group of devices, and means for transmitting the first level start-up authorization response with the first authorization signature comprises: means for in accordance with a determination that the verification of the first identification signature is correct, verifying the at least one slave identification signature with at least one second slave identification key recorded in a constitution integrity table for indicating associations between the group of the devices; and means for in accordance with a determination that the verification of the at least one slave identification signature is correct, transmit, to the master device, the first level start-up authorization response with the first authorization signature, the first level start-up authorization response being nested with at least one slave authorization signature corresponding to the at least one slave device in the order of device levels of the group of devices.

In some example embodiments, the master device comprises a network device integrated with an AAA client, and the network device comprises a AAA server and a central database.

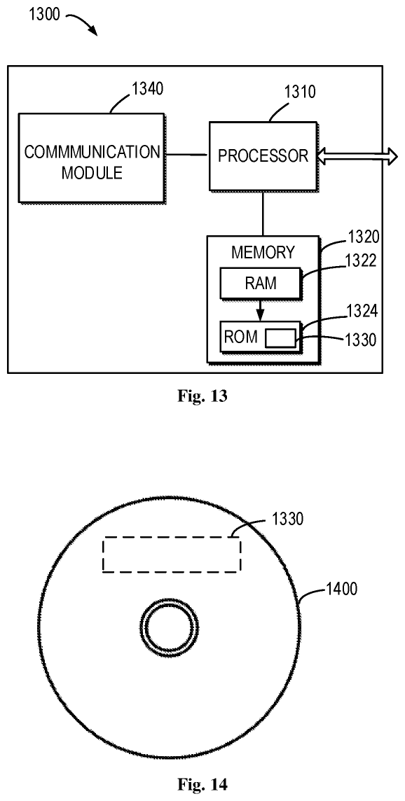

FIG. 13 is a simplified block diagram of a device 1300 that is suitable for implementing embodiments of the present disclosure. The device 1300 may be provided to implement the communication device, for example any of the network devices 102 to 106 or the network device 130 as shown in FIG. 1. As shown, the device 1300 includes one or more processors 1310, one or more memories 1320 coupled to the processor 1310, and one or more communication modules 1340 coupled to the processor 1310.

The communication module 1340 is for bidirectional communications. The communication module 1340 has at least one antenna to facilitate communication. The communication interface may represent any interface that is necessary for communication with other network elements.

The processor 1310 may be of any type suitable to the local technical network and may include one or more of the following: general purpose computers, special purpose computers, microprocessors, digital signal processors (DSPs) and processors based on multicore processor architecture, as non-limiting examples. The device 1300 may have multiple processors, such as an application specific integrated circuit chip that is slaved in time to a clock which synchronizes the main processor.

The memory 1320 may include one or more non-volatile memories and one or more volatile memories. Examples of the non-volatile memories include, but are not limited to, a Read Only Memory (ROM) 1324, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1322 and other volatile memories that will not last in the power-down duration.

A computer program 1330 includes computer executable instructions that are executed by the associated processor 1310. The program 1330 may be stored in the ROM 1320. The processor 1310 may perform any suitable actions and processing by loading the program 1330 into the RAM 1320.

The embodiments of the present disclosure may be implemented by means of the program 1330 so that the device 1300 may perform any process of the disclosure as discussed with reference to FIGS. 10 to 12. The embodiments of the present disclosure may also be implemented by hardware or by a combination of software and hardware.

In some embodiments, the program 1330 may be tangibly contained in a computer readable medium which may be included in the device 1300 (such as in the memory 1320) or other storage devices that are accessible by the device 1300. The device 1300 may load the program 1330 from the computer readable medium to the RAM 1322 for execution. The computer readable medium may include any types of tangible non-volatile storage, such as ROM, EPROM, a flash memory, a hard disk, CD, DVD, and the like. FIG. 14 shows an example of the computer readable medium 1300 in form of CD or DVD. The computer readable medium has the program 1330 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 1000, 1100 or 1200 as described above with reference to FIGS. 10-12. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-70. (canceled)

71. A master device, comprising:
at least one processor; and
at least one memory including computer program codes;
the at least one memory and the computer program codes are configured to, with the at least one processor, cause the master device at least to:
transmit, to a network device, a first level start-up request with a first identification signature corresponding to a first identification key for identifying the master device, the first identification key being generated based on a master key specific to the master device;
receive, from the network device, a first level start-up authorization response with a first authorization signature corresponding to a second identification key; and
verify the first authorization signature with the first identification key.

72. The master device of claim 71, wherein the master device is further caused to:
in accordance with a determination that the verification of the first authorization signature is correct, complete the start-up of the master device; and
in accordance with a determination that the verification of the first authorization signature is incorrect, drop the first level start-up authorization response.

73. The master device of claim 71, wherein the master device is further caused to:
receive, from the network device, configuration file comprising sensitive data, the configuration file being encrypted with a second data encryption key; and
decrypt the encrypted configuration file with a first data encryption key, the first data encryption key being generated based on the master key specific to the master device.

74. The master device of claim 71, wherein the master device is further caused to:
in accordance with a determination of sensitive data to be written into the master device, encrypt the sensitive data with a first data encryption key, the first data encryption key being generated based on the master key specific to the master device; and
write the encrypted sensitive data into the master device.

75. The master device of claim 72, wherein the master device is comprised in a group of devices with at least one slave device, and each of the group of devices is assigned with a corresponding device level, and the master device is further caused to:
receive, from the network device, a challenge message for verifying a constitution integrity of the group, the challenge message being with a challenge signature corresponding to the second identification key, and nested with at least one slave challenge signature corresponding to at least one slave identification key for identifying the at least one slave device in the order of device levels;
verify the challenge signature with the first identification key specific to the master device;
in accordance with a determination that the verification of the challenge signature is correct,
extract an internal layer of the challenge message; and
transmit the internal layer of the challenge message to a first slave device, a device level of the first slave device is one device level lower than that of the master device; and
in accordance with a determination that the verification of the challenge signature is incorrect, drop the challenge message.

76. The master device of claim 71, wherein the master device is further caused to:
determine a first crypto-checksum based on a first integrity key for checking integrity of data and a current version of the data stored on the master device, the first integrity key being generated based on the master key specific to the master device; and
in accordance with a determination that the first crypto-checksum is the same as a second crypto-checksum obtained from an network device, determine that an integrity check on the master device is completed, the second crypto-checksum being generated by the network device based on a stored version of the data and a second integrity key.

77. The master device of claim 71, wherein the master device is further caused to:
update the master key based on a preconfigured key updating rule; and
update at least the first identification key based on the updated master key.

78. The master device of claim 77, wherein the master device is caused to update the master key by:
receiving, from the network device, a key update message indicative of updating the master key; and
in response to the key update message, updating the master key based on the preconfigured key updating rule.

79. The master device of claim 71, wherein the master device is comprised in a group of devices with at least one slave device, and each of the group of devices is assigned with a corresponding device level, and the master device is further caused to:
receive, from a first slave device of the group of devices, a second level start-up request with a first slave identification signature corresponding to a slave identification key for identifying the first slave device, a device level of the first slave device being one device level lower than that of the master device; and
encapsulate the second level start-up request with the first slave identification signature into the first level start-up request.

80. The master device of claim 79, wherein the first level start-up authorization response is nested with at least a second level authorization signature corresponding to the first slave device, and the first device is further caused to:
in accordance with a determination that the verification of the first authorization signature is correct,
extract an internal layer of the first level start-up authorization response; and
transmit the internal layer of the first level start-up authorization response to the first slave device; and
in accordance with a determination that the verification of the first authorization signature is incorrect, drop the first level start-up authorization response.

81. A slave device, comprising:
at least one processor; and
at least one memory including computer program codes;
the at least one memory and the computer program codes are configured to, with the at least one processor, cause the slave device at least to:
transmit, to a first target device, a second level start-up request with a first slave identification signature corresponding to a first slave identification key for identifying the slave device, the first slave identification key being generated based on a master key specific to the slave device;
receive, from the first target device, a second level start-up authorization response with a first slave authorization signature corresponding to a second slave identification key, the slave device and the first target device being comprised in a group of devices each assigned with a corresponding device level, and a device level of the slave device is one device level lower than that of the first target device; and
verify the first slave authorization signature with the first slave identification key.

82. The slave device of claim 81, wherein the slave device is further caused to:
in accordance with a determination that the verification of the first slave authorization signature is correct, complete the start-up of the slave device; and
in accordance with a determination that the verification of the first slave authorization signature is incorrect, drop the second level start-up authorization response.

83. The slave device of claim 81, wherein the second level start-up authorization response with the first slave authorization signature is an internal layer of a first level start-up authorization response extracted by the first target device with the first identification key specific to the first target device, and the first level start-up authorization response is generated and nested, by the network device, with a first authorization signature corresponding to a second identification key specific to the first target device and the first slave authorization signature corresponding to a second slave identification key in the order of device levels.

84. The slave device of claim 81, wherein the slave device is further caused to:
receive, from the first target device, configuration file including sensitive data, the configuration file being delivered from a network device and encrypted with a second slave data encryption key; and
decrypt the encrypted configuration file with a first slave data encryption key, the first slave data encryption key being generated based on the master key specific to the slave device.

85. The slave device of claim 81, wherein the slave device is further caused to:
in accordance with a determination of sensitive data to be written into the slave device, encrypt the sensitive data with a first slave data encryption key, the first slave data encryption key being generated based on the master key specific to the slave device; and
write the encrypted sensitive data into the slave device.

86. The slave device of claim 81, wherein the slave device is of a lowest device level in the group of devices, and the slave device is further caused to:
in accordance with a determination that the verification of the first slave authorization signature is correct, complete the start-up of the slave device;
receive, from the first target device, a second level challenge message for verifying a constitution integrity of the group of devices, the second level challenge message being with a slave challenge signature corresponding to the second slave identification key;
verify the slave challenge signature with the first slave identification key specific to the slave device;
in accordance with a determination that the verification of the slave challenge signature is correct, transmit, to the first target device, another second level start-up request with the first slave identification signature corresponding to the first slave identification key; and
in accordance with a determination that the verification of the slave challenge signature is incorrect, drop the second level challenge message.

87. The slave device of claim 81, wherein the slave device is further caused to:
in accordance with a determination that the verification of the first slave authorization signature is correct, complete the start-up of the slave device;
update the master key based on a preconfigured key updating rule; and
update at least the first slave identification key based on the updated master key.

88. The slave device of claim 87, wherein the slave device is caused to update the master key by:
receiving, from the first target device, a second level key update message indicative of updating the master key; and
in response to the second level key update message, updating the master key based on the preconfigured key updating rule.

89. A network device, comprising:
at least one processor; and
at least one memory including computer program codes;
the at least one memory and the computer program codes are configured to, with the at least one processor, cause the network device at least to:
receive, from a master device, a first level start-up request with a first identification signature corresponding to a first identification key for identifying the master device, the first identification key being generated based on a master key specific to the master device;
verify the first identification signature with a second identification key; and
in accordance with a determination that the verification of the first identification signature is correct, transmit, to the master device, a first level start-up authorization response with a first authorization signature corresponding to the second identification key.

90. The network device of claim 89, wherein the master device is included in a group of devices with at least one slave device, and each of the group of devices is assigned with a corresponding device level, and the network device is further caused to:
transmit, to the master device, a challenge message for verifying a constitution integrity of the group, the challenge message being with a challenge signature corresponding to the second identification key, and nested with at least one slave challenge signatures corresponding to at least one slave identification key for identifying the at least one slave device in the order of device levels;
receive, from the master device, another first level start-up request being with the first identification signature and nested with the at least one slave identification signatures; and
verify the nested at least one slave identification signatures with at least one second slave identification key recorded in a constitution integrity table for indicating associations between the group of the devices.
